(19) United States
(12) Patent Application Publication
(10) Pub. No.: US 2026/0336458 A1
(43) Pub. Date: Oct. 29, 2026

(54) VEHICLE SYSTEM WITH POLY-STATE SERIAL COMMUNICATION OVER A PULSE WIDTH MODULATION LINE

(71) Applicant: Textron Inc., Providence, RI (US)

(72) Inventors: Gregory August Theodosakis, Martinez, GA (US); Russell William King, Evans, GA (US); Charles Daniel Dauchess, North Augusta, SC (US); Matthew Jacob Noftsger, Evans, GA (US)

(73) Assignee: Textron Inc., Providence, RI (US)

(21) Appl. No.: 19/191,491

(22) Filed: Apr. 28, 2025

(51) Int. Cl. B60L 53/66; B60L 53/62; B60L 53/68

(52) U.S. Cl. CPC B60L 53/66; B60L 53/62; B60L 53/68

(57) ABSTRACT

A vehicle system includes a vehicle and processing circuitry to communicate to an charger using a pulse width modulation (PWM) signal. The system allows communications to be interrupted for higher priority information by using different values for the duty cycle of the PWM signal. The system requests termination of charging or electrical disconnection from the charger by using a specific value for the duty cycle of the PWM signal. PWM duty cycles allow for identifying a device communicating the based on the duty cycles used to perform the communication. A second form of identification can be used to identify a fault condition. The PWM signal further allows simultaneous communication of more than one digital symbol by assigning a number of digital symbols to each of a number of duty cycles. Communication to or from additional devices is achieved using multiple duty cycles.

### BACKGROUND

Recreational vehicles may include a battery system to provide power to propel the vehicle forward and/or to power ancillary vehicle systems. The battery system of the vehicle may be charged by connecting a battery charging system.

### SUMMARY

One embodiment relates to a vehicle system. The vehicle system includes a vehicle having a battery and a charger connection interface configured to connect to a charger. The vehicle system also includes one or more processing circuits configured to transmit or receive digital data using a pulse width modulation signal between the vehicle and the charger, a low state of the digital data represented by a first duty cycle of the pulse width modulation signal and a high state of the digital data represented by a second duty cycle of the pulse width modulation signal. The one or more processing circuits are also configured to interrupt transmission or reception of the digital data by generating a signal on the pulse width modulation signal using a third duty cycle different than the first duty cycle and the second duty cycle to provide information of higher priority.

Another embodiment relates to a vehicle system. The vehicle system includes one or more processing circuits configured to transmit or receive digital data using a pulse width modulation signal, a low state of the digital data represented by a first duty cycle of the pulse width modulation signal and a high state of the digital data represented by a second duty cycle of the pulse width modulation signal. The one or more processing circuits are also configured to (i) transmit the pulse width modulation signal at a third duty cycle responsive to a fault condition, or (ii) perform a fault mitigation action responsive to receiving a second pulse width modulation signal at the third duty cycle.

Still another embodiment relates to a vehicle system. The vehicle system includes one or more processing circuits configured to transmit or receive digital data using a pulse width modulation signal on an electrical connection, a low state of the digital data represented by a first duty cycle of the pulse width modulation signal and a high state of the digital data represented by a second duty cycle of the pulse width modulation signal. The one or more processing circuits are also configured to perform an identification of a device communicating on the electrical connection based on the first duty cycle or the second duty cycle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a schematic block diagram of a vehicle system including the vehicle of FIG. 1 and a battery charger configured to communicate using a pulse width modulation (PWM) line, according to an exemplary embodiment.

FIG. 6 is a schematic block diagram of the fleet monitoring and control system of FIG. 4 including a plurality of vehicles of FIG. 1 and a battery charging system, according to an exemplary embodiment.

FIG. 7 is a timing diagram illustrating communication between a vehicle of FIG. 1 and a battery charger during charge initialization, according to an exemplary embodiment.

FIG. 8 is a flow diagram of a method for performing vehicle charging using communication over a PWM line, according to an exemplary embodiment.

FIG. 9 is another timing diagram illustrating communication between a vehicle of FIG. 1 and a battery charger during charge initialization when more than one binary symbol is transmitted during a single communication clock pulse and over a single PWM line, according to an exemplary embodiment.

FIG. 10 is a flow diagram of a method for communicating information over a PWM line, according to an exemplary embodiment.

FIG. 11 is a flow diagram of a method for responding to a fault condition during communication over a PWM line, according to an exemplary embodiment.

FIG. 12 is a flow diagram of a method for identifying a fault condition based on two identification techniques during communication over a PWM line, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

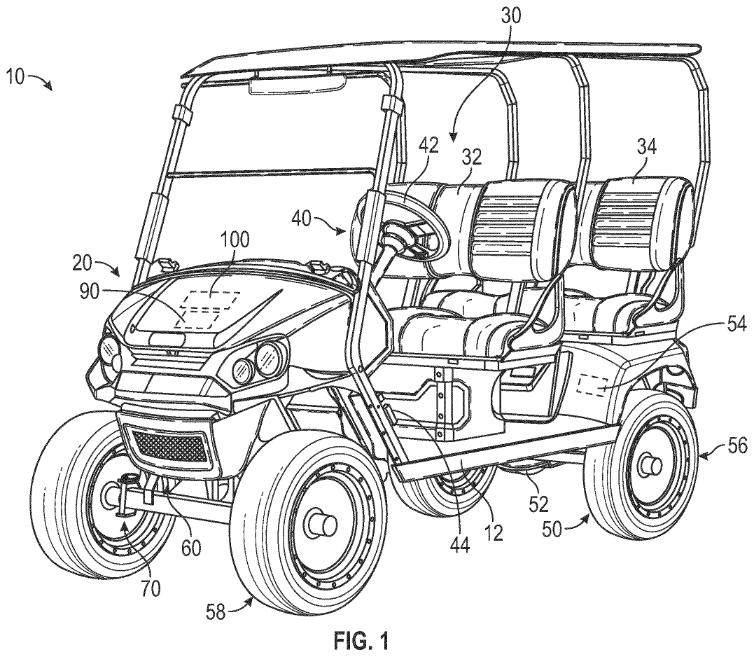

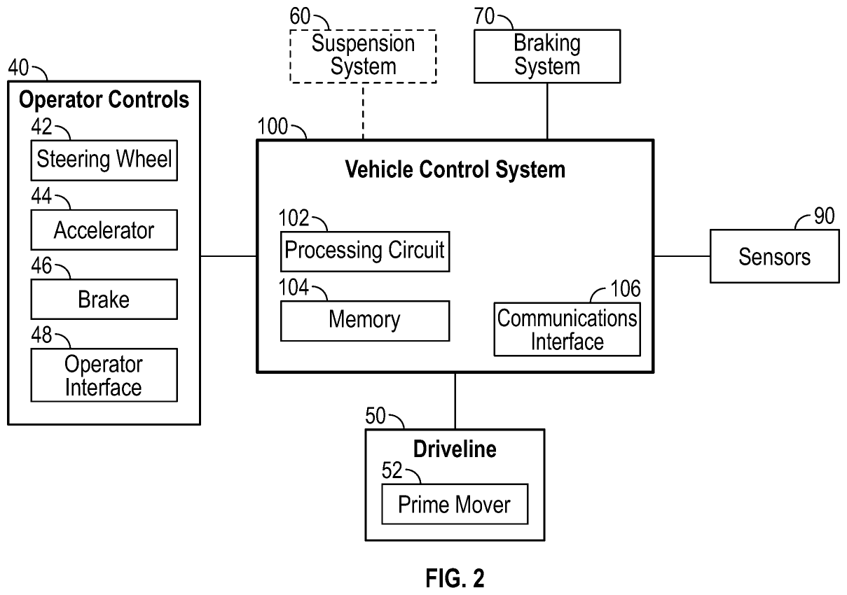

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

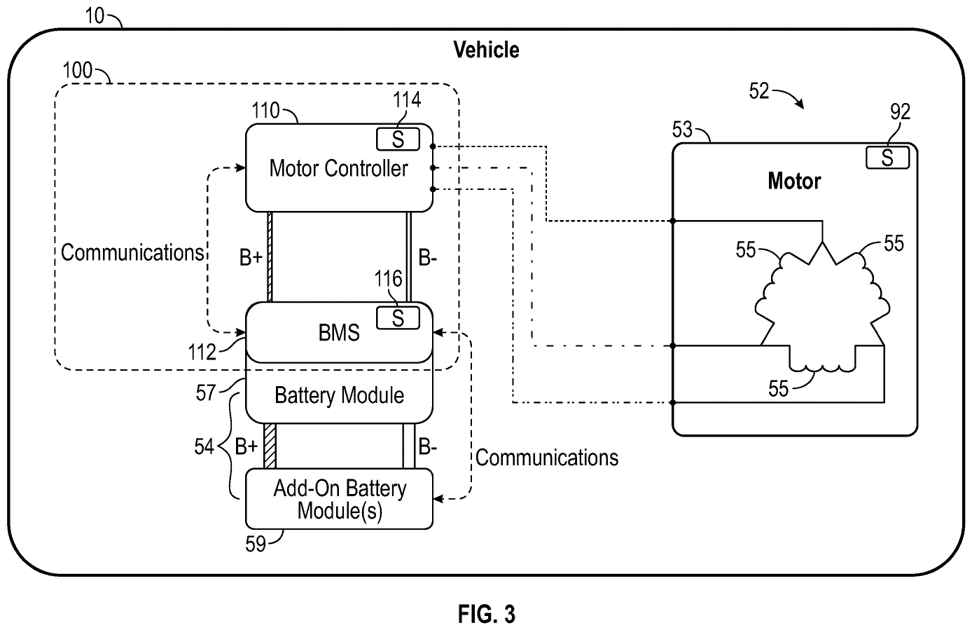

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is (are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

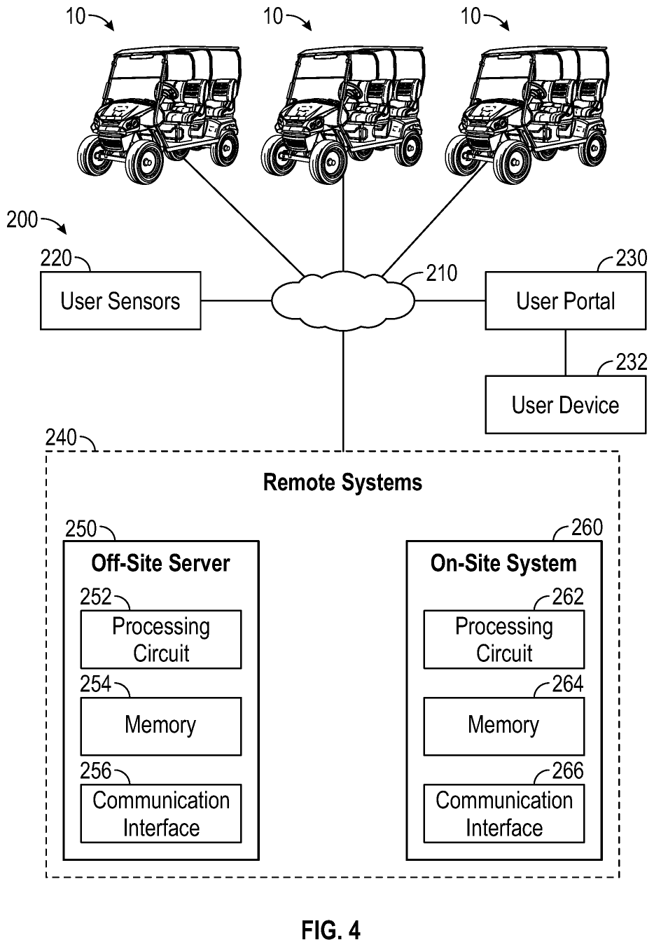

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Poly-State Serial Communication Over a Pulse Width Modulation Line

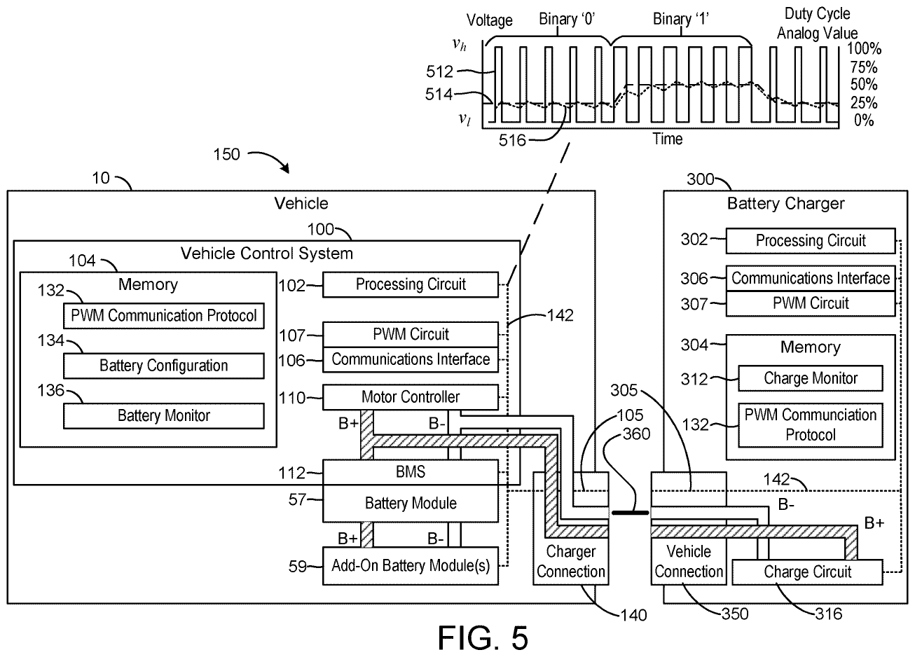

FIG. 5 shows a vehicle system 150 including a block diagram of the vehicle 10 and a block diagram of a battery charger 300 according to an exemplary embodiment. According to an exemplary embodiment, the vehicle 10 is configured to communicate (e.g., request information, send commands, send information, etc.) with the battery charger 300 over a pulse width modulation (PWM) line 142 (e.g., connection, bus, link, wire, trace, path, etc.). By way of example, the PWM line 142 may include circuit traces and wires of the vehicle 10, circuit traces and wires of the battery charger 300, as well as a connection between the battery charger 300 and the vehicle 10 including a PWM connector 105 on the vehicle 10 to connect to a PWM connector 305 on the battery charger 300, and a cable 360 including a wire for the PWM connectivity between the PWM connector 105 and the PWM connector 305. Additionally or alternatively, the vehicle 10 and/or the battery charger 300 may perform internal communication (e.g., among components of the vehicle 10 or the battery charger 300 using an internal PWM line 142. The PWM line 142 may be used to exchange information during charging. For example, the vehicle 10 may request a certain charging rate (e.g., electrical current) and/or provide battery specifications to the battery charger 300.

In some embodiments, the battery charger 300 is an off-board charger. The vehicle 10 may use the cable 360 to connect to the battery charger 300 for charging. During operation the cable 360 may be removed from the vehicle 10, retracted into the vehicle body or housing of the battery charger 300, or otherwise disconnected.

Alternatively, the battery charger 300 may be mounted or otherwise coupled to the vehicle 10. The cable 360 may remain connected between the battery charger 300 and the vehicle control system 100. To charge, the on-board (e.g., mounted, integrated) battery charger 300 may connect to an electrical outlet. For example, the vehicle 10 may connect to a standard wall mounted electrical outlet (e.g., 120 V, 240 V, etc.) using standard cabling (e.g., an extension cord, etc.). An on-board charger may simplify the design of the connection between the vehicle 10 and the battery charger 300. For example, housings (e.g., ports, etc.) to allow for removable connections may not be required.

During the course of charging the battery (e.g., in the battery module 57 and/or add-on battery module 59), the vehicle 10 may request a specific target voltage for charging and/or a specific target charging rate or current. The target voltage may depend on the model number of the vehicle 10 or the configuration of the battery module 57 or the add-on battery module 59. The charge rate may also depend on the model number of the vehicle 10 or the configuration of the battery module 57 or the add-on battery module 59. Additionally or alternatively, the charge rate may depend on when the charging is to be completed or when the vehicle 10 is scheduled to be used again (e.g., by way of user configuration or entry through the operator interface 48). For example, battery life may be extended by charging the battery at a slow rate (e.g., low electrical current) when possible. Using communication over the PWM line 142, the vehicle 10 may request a specific voltage and current, and the battery charger 300 may provide charge at the requested voltage and current. For example, the processing circuit 302 may configure a charge circuit 316 to provide the specified voltage on the B+ connection and limit the charge to the specified current in response to the request from the vehicle 10.

Communicating over the PWM line 142 may provide advantages over communicating using a general-purpose binary input/output line. In some embodiments, a binary zero (e.g., ‘0’, false, low, etc.) may be represented by a first duty cycle of the PWM signal on the PWM line 142 and a binary one (e.g., ‘1’, true, high, etc.) may be indicated by a second duty cycle. Any duty cycle other than the first duty cycle or the second duty cycle may be indicative of a fault allowing circuits connected to the PWM line 142 to take immediate action. In some embodiments, more than one binary symbol can be simultaneously communicated using a number of duty cycles. For example, a duty cycle of 20% may represent the binary sequence ‘00’, a duty cycle of 40% may represent ‘01’, a duty cycle of 60% may represent ‘10’, and a duty cycle of 80% may represent ‘11’. In some embodiments, the duty cycle used to represent a ‘0’ or a ‘1’ may represent a priority and/or an identity of the communication (e.g., specific source device, type of source device, communication type, etc.). Various configurations of the vehicle 10 and/or the battery charger 300 may use more than one of the described advantages in combination to provide enhanced vehicle communication and/or charging.

As shown in FIG. 5, the vehicle 10 includes a charger connection 140 which may be used to connect the battery charger 300 to the vehicle 10 and provide power to the battery module 57 and/or the add-on battery module 59. In addition, the vehicle control system 100 includes a PWM circuit 107. The PWM circuit 107 may be one or more electronic components configured to provide a PWM signal 512 at a specified duty cycle. The PWM circuit 107 may be a portion of the processing circuit 102. For example, a microcontroller and/or a microprocessor of the processing circuit 102 may have an integrated PWM interface and provide one or more pins (e.g., connection points, etc.) that can be used as an output to generate a PWM signal 512 or as input to determine the duty cycle of a PWM signal generated by a different circuit. The PWM circuit 107 may, additionally or alternatively, be a portion of the communications interface 106. For example, the communications interface 106 may include circuitry (e.g., specific integrated circuits, another microcontroller, etc.) to generate a PWM signal based on information received from the processing circuit 102. The processing circuit 102 may provide a duty cycle to the communications interface 106 (e.g., using a different communication line and/or protocol) and cause the PWM circuit 107 of the communications interface 106 to generate a PWM signal with the requested duty cycle at the time of the request (e.g., starting at the time of the request, until a new request, etc.).

In some embodiments, communication using PWM is performed by first encoding a binary sequence into an information signal (e.g., the information signal 514 of the breakout plot of FIG. 5). Encoding may be performed by converting one or more binary symbols into a duty cycle for a period of time. By way of an example, in FIG. 5, each binary symbol may be represented by the information signal 514 having a value of a specific duty cycle for a period of time. The period of time may be equal to the communication clock period (e.g., 104 μs, 26 μs) which, in some embodiments, is based on the communication speed (e.g., symbol changes per second: 9600 baud, 38400 baud, etc. or bit rate per second 9600 bps, 76800 bps, etc., slower bitrates and/or symbols per second of 4 bps, 40 bps, 400 bps, etc. may be used, for example, due to hardware limitations) A binary ‘0’ may be indicated in the information signal 514 having a first value for the duty cycle and a binary ‘1’ may be indicated by the information signal 514 having a second value for the duty cycle. The first value and the second value used to encode the binary symbols into the information signal 514 may be any values shared between the devices communicating using PWM. The first value may be less than the second value or the first value may be greater than the second value. In some embodiments, the values may change (e.g., rotate), for example, based on a time of day, randomly, etc. to provide fault detection and/or increased security. Other constraints may be placed on the first and/or second values to allow for fault detection or to allow for improved communication (e.g., lower error rate). For example, the first and second values may have to have a difference of a particular amount (e.g., 50%), the first and second values may satisfy a shared equation (e.g., x₂+2x₁=100% where x₁ and x₂ are the first and second values, respectively), or any other restriction may be placed on the first and second values that allow a circuit to detect if the communication is faulty. In FIG. 5 the first value is shown to be 25% and the second value is shown to be 50%.

The information signal 514 may be converted to a PWM signal 512 (e.g., by the PWM circuit 107). The PWM signal 512 is shown to rapidly change (e.g., changes more often than the information signal 514) between a low voltage level, vₗ, and a high voltage level, vₕ. As shown in FIG. 5, the PWM signal 512 spends a percentage of time at the high voltage level equal to the value of the information signal 514. Thus, the PWM signal 512 may represent a binary ‘0’ by spending a first percentage of time (equal to the first value of the information signal 514) at the high voltage level (e.g., 25%) and the rest of the time at the low voltage level. A binary ‘1’ may be indicated in the PWM signal 512 by spending a second percentage of time (equal to the second value of the information signal 514) at the high voltage level (e.g., 50%) and the rest of the time at the low voltage level. To communicate different binary symbols, the PWM signal 512 may change the percentage of time spent at the high voltage level (e.g., as the information signal 514 changes). The percentage of time spent at the high voltage level may also be referred to as the duty cycle of the PWM signal 512.

The PWM signal 512 may change between voltage levels faster than the information signal. For example, a number of periods of the PWM signal 512 (e.g., 5 periods, 10 periods, 100 periods, etc.) may be used to communicate a single value of the information signal. It may be necessary for the receiving circuit to receive a number of periods before the receiving circuit is able to determine the correct duty cycle and thus the binary symbol.

In some embodiments, the PWM signal 512 may be filtered (e.g., by a capacitive circuit) to cause a filtered PWM signal 516 to be similar to (e.g., proportional to) the information signal 514. For example, a filter may cause the filtered PWM signal 516 to have an average voltage equal to:

v_{PWM}=d(vₕ−vₗ)+vₗ,

where v_{PWM} is the average voltage of the filtered PWM signal 516 and d is the duty cycle of the PWM signal 512 (and the value of the information signal 514). The filter may be configured to allow the voltage to rapidly change when the information signal 514 changes, but minimize any ripple included on the voltage of the filtered PWM signal 516. Using an information signal 514 that has a frequency significantly slower (e.g., has a longer period) than that of the PWM signal 512 may allow for improved rejection of the voltage ripple while allowing the voltage of the filtered PWM signal 516 to change within the period of the information signal.

The PWM circuit 107 may be configured to provide communications between the vehicle 10 and the battery charger 300 by generating and receiving PWM signals 512 as described herein. In some embodiments, the PWM circuit 107 may be configured to provide communications between the various vehicle systems of the vehicle 10. For example, the PWM circuit 107 may be used during communication between the vehicle control system 100, the sensors 90, the braking system 70 the suspension system 60, the driveline 50, motor controller 110, BMS 112, battery module 57, add-on battery module 59, and/or operator controls 40.

The PWM circuit 107 may use a PWM communication protocol 132 to provide communication between the components of the vehicle 10 and/or the battery charger 300. The PWM communication protocol 132 may be accessed by any of the devices of the vehicle 10 to transmit and/or receive messages over the PWM line 142. The battery charger 300 may have a similar PWM communication protocol 132 to allow the battery charger 300 to communicate with the vehicle 10 and/or internally via the PWM line 142. The PWM communication protocol 132 may be a standard protocol (e.g., universal asynchronous receiver/transmitter (UART), etc.) with the exception that binary symbols are represented by a specific duty cycle on the PWM line 142 or the PWM communication protocol 132 may be a proprietary communication protocol using the PWM signals 512 described herein.

The PWM circuit 107 may be configured to both send (e.g., transmit, broadcast, etc.) and receive (e.g., acquire, accept, etc.) communications on a single PWM line 142. The PWM circuit 107 may be configured to change between a transmission mode and a reception mode based on a clock or an indication on the PWM line 142. The PWM communication protocol 132 may provide instructions to the PWM circuit 107 to determine when the PWM circuit 107 should be configured to transmit and when it should be configured to receive. In some embodiments, the mode changes may be in response to a communication collision (e.g., two components attempting to initiate transmission at the same time).

In some embodiments, the PWM communication protocol 132 is configured to allow component identification (e.g., unique identity of the source or type of the source) based on the duty cycles used by the PWM signal 512 to represent the binary symbol ‘0’ (e.g., the first value of the duty cycle) and/or the binary symbol ‘1’ (e.g., the second value of the duty cycle). For example, the PWM communication protocol 132 may be configured to recognize that a PWM signal 512 that changes between a duty cycle of 40% (e.g., the first value to represent ‘0’) and 75% (e.g., the second value to represent ‘1’) is from the braking system 70. Each component of the vehicle system 150 (e.g., the vehicle control system 100, the operator interface 48, the battery charger 300) may be assigned a unique first value and second value to represent the binary symbols that the component transmits.

In some embodiments, the PWM communication protocol 132 is configured to allow destination identification based on the duty cycles used by the PWM signal 512 to represent the binary symbol ‘0’ (e.g., the first value of the duty cycle) and/or the binary symbol ‘1’ (e.g., the second value of the duty cycle). Additionally or alternatively, the PWM communication protocol 132 may assign each component a single value (e.g., duty cycle percentage). The single value can be used to identify it as the source of the transmission and the single value of a different component may be used to indicate the destination of the communication. For example, the source may be indicated by the component sending the communication using its single value as to represent the binary symbol ‘0’ and the destination may be represented by the component sending the communication using the single value of the destination component to represent the binary symbol ‘1’. The destination device is not currently transmitting and thus would understand that its single value on the PWM line 142 represents a message for it to receive and is the duty cycle of a binary ‘1’. One minus the single value of the destination device may alternatively be used to represent a binary ‘1’, thus if all single values for a component are between 0 and 50% the duty cycle for a binary ‘1’ would be greater than 50%.

The PWM communication protocol 132 may be configured such that each component has a specific order or time at which they are able to communicate (e.g., a token-passing network). The PWM communication protocol 132 can provide a first form of identification based on the timing and/or order for which they communicate. By way of example, a first form of identification may be based on the holder of the token in a token passing network. The PWM communication protocol 132 may provide a second form of identification based on the value of the duty cycle used to represent a binary ‘0’ and/or a binary ‘1’. By providing two forms of identification the PWM communication protocol 132 may also be configured to provide fault detection by comparing both forms of identification. If the two identifications do not match the PWM communication protocol 132 may output an error. For example, the error may be displayed on the operator interface 48, disconnect the battery charger 300, cause a restart (e.g., reset) of the communication, cause a reset of the potentially offending components (e.g., both components that were identified), or any other suitable technique that may clear the communication problem and/or mitigate any effect of the fault.

The PWM communication protocol 132 may associate certain values of the duty cycle of the PWM signal 512 with priority communications. For example, a PWM signal 512 for which the duty cycle drops below a threshold (e.g., below 2% or below 5%) may be associated with an interrupt condition during which all components that did not transmit using a duty cycle below the threshold stop communicating to receive the priority message. In some embodiments, specific priority messages are associated with a particular duty cycle. For example, a duty cycle near 0% and/or 100% (e.g., exceeding a low or high threshold) may be used to quickly disconnect the battery charger 300 from the vehicle 10. The disconnect request may be sent by either a component of the vehicle 10 or a component of the battery charger 300 to indicate an electrical fault that requires a disconnect to mitigate the risk of a more severe failure (e.g., battery failure, etc.). Advantageously, a duty cycle exceeding (e.g., less than) a low threshold and/or a duty cycle exceeding (e.g., greater than) a high threshold may be used to communicate a disconnect request because certain electrical failures (e.g., a short, a failed cable, failed circuitry components, etc.) may manifest as a constant high or low voltage on the PWM line 142 and the battery charger 300 may be quickly disconnected from the vehicle 10 before additional damage occurs.

In some embodiments, the PWM communication protocol 132 communicates more than one symbol per communication clock cycle (e.g., period of the information signal 514). The information signal 514 may change values (e.g., and the PWM signal 512 may change duty cycle) at a particular frequency (e.g., baud rate) and the number of binary symbols transmitted per second may be an integer multiple of the frequency or baud rate. In some embodiments, a range of duty cycles (e.g., 0-100% or 10-90% if high and/or low thresholds are used to indicate errors) is split into a power of base 2 number of bands, where the power is the number of symbols that are communicated per communication clock cycle. The thresholds of the duty cycle bands may be given by:

$${τ}_{b} = \frac{b}{{2}^{n}} ( {d}_{h} - {d}_{l} ) + {d}_{l} , ∀ b = 1 … {2}^{n} ,$$

where τ_{b} is the threshold for the b^{th} sequence of n symbols.

By way of non-limiting example, the PWM communication protocol 132 may be configured to communicate three symbols simultaneously (n=3). Duty cycles less than 10% and/or greater than 90% may be indicative of an error or fault, thus the range of duty cycles for standard communication may be 10-90% (dₕ=90% and dₗ=10%). The first sequence of n binary symbols (b=1) may be the sequence ‘000’ and may be represented by a duty cycle of less than the first threshold τ₁=20%. The target duty cycle for the sequence ‘000’ may be in the center of the range between dₗ and τ₁ (e.g., 15%). Any duty cycle between 10% and 20% would be recognized as ‘000’ allowing for a margin of error in determining the transmitted duty cycle. The second sequence of n binary symbols (b=2) may be the sequence ‘001’ and be represented by a duty cycle of less than the first threshold τ₂=30%. Accordingly, the target duty cycle for the sequence ‘001’ may be in the center of the range between τ₁ and τ₂ (e.g., 25%). Any duty cycle between 20% and 30% would be recognized as ‘001’ again allowing for a margin of error in determining the transmitted duty cycle. A similar procedure could be used to calculate each of the eight thresholds and target duty cycles for the eight possible sequences of three binary symbols.

The PWM communication protocol 132 may use a combination of techniques for communicating more than one binary symbol per clock cycle on the PWM line 142, indicating faults by way of a specific duty cycle, and/or providing for component identification based on the duty cycle of the PWM line 142.

A battery configuration 134 may be stored in the memory 104. In some embodiments, the battery configuration 134 is used by the vehicle control system 100 to determine an appropriate charging voltage and/or charging current for the equipped battery module 57 and/or add-on battery module 59. The charging voltage and/or the charging current may be constant or the charging voltage and/or the charging current may change as a function of the state-of-charge of the battery. Charge voltage and/or current profiles as a function of the state-of-charge may be stored by the battery configuration 134 and used by the vehicle control system 100 upon request (e.g., when the BMS 112 checks if the charge current should be modified).

In some embodiments, the battery configuration 134 is configured to store the charging voltages and/or currents for the particular battery configuration of the vehicle 10. Additionally or alternatively, the battery configuration 134 may be configured to store the configuration of the battery, which the vehicle control system 100 can use to calculate the appropriate voltages and/or currents. For example, the battery configuration 134 may store the capacity of the equipped batteries (e.g., Amp-hours, kilojoules, etc.), the maximum charge and/or discharge current, how different charge and/or discharge currents affect battery life, etc. The battery configuration 134 may perform calculations related to the equipped batteries (e.g., calculating remaining charge, estimated hours of use, estimated range, etc.).

Information stored and/or calculated by the battery configuration 134 may be communicated using the PWM line 142 to the battery charger 300. The battery charger 300 may, for example, display the information from the battery configuration 134.

The vehicle control system 100 may include a battery monitor 136. In some embodiments, the battery monitor 136 is configured to detect fault conditions (e.g., errors, etc.) related to the battery module 57, add-on battery module 59, and/or BMS 112. The battery monitor 136 may detect a fault and cause the fault to be indicated by a duty cycle on the PWM line 142 that exceeds a fault threshold (e.g., low threshold or high threshold). The battery monitor 136 may detect faults in addition to those faults that manifest with the PWM line 142 exceeding the fault threshold. For example, the battery monitor 136 may monitor for overtemperature, a rapid increase in charge current, a change in charge voltage, etc. and request (e.g., command, cause, etc.) the battery charger 300 to be electrically disconnected from the vehicle 10 by driving the duty cycle of the PWM line 142 to exceed the fault threshold.

The charger connection 140 is shown to have three connections: (a) a PWM connection for the charger 105 to provide a communicative connection to the battery charger 300 over the PWM line 142, (b) a B+ connection to provide positive voltage to charge the batteries of the vehicle 10, and (c) a B− connection to provide a negative battery connection or reference voltage for the B+ connection. Advantageously, the communication methods over the PWM line 142 described herein allow for a significant amount of information to be carried over a single communication connection. Additional connections may be added to provide other functionality as needed.

The charger connection 140 may be any appropriate connection housing. For example, the connection housing may be a receptacle type housing with conductive contact points (e.g., pins, slots, etc.) to allow for an electrical connection to be made between the cable 360 and the charger connection 140. The housing may be of any suitable shape (e.g., triangular, rectangular, circular, etc.) and may have keying (e.g., protrusions or other shape irregularities) to prevent incorrect installation.

In some embodiments, the charger connection 140 includes circuitry to allow for disconnecting the battery charger 300 from the vehicle 10. For example, the cable 360 from the battery charger 300 may remain attached to the charger connection 140, but the battery charger 300 may be electrically disconnected from the vehicle 10. The charger connection 140 may monitor the PWM line 142 for any indication that the battery charger 300 and the vehicle 10 should be disconnected (e.g., a very low or very high duty cycle of the PWM signal 512 as described above). Upon detection of a disconnect command (e.g., signal, request, etc.), the charger connection 140 may activate (e.g., open or close) one or more electrical relays that are inline with the battery charger 300. The activation of the relay may latch in the disconnected state until a person can acknowledge the issue and reset the connection.

The cable 360 may be an electrically conductive three wire cable. The cable 360 may have one wire to connect the positive voltage (B+) of the battery charger 300 to the positive voltage (B+) of the vehicle 10, one wire to connect the negative or reference voltage (B−) of the battery charger 300 to the negative or reference voltage (B−) of the vehicle 10, and one wire to connect the PWM communication lines (e.g., busses) of the vehicle 10 and the battery charger 300. To allow for greater levels of current on the B+ wire and the B− wire, these wires may be of greater diameter than the wire to connect the PWM communication lines. In some embodiments, the cable 360 is an integrated part of the vehicle 10 or the battery charger 300. For example, the cable 360 may retract into the body of the vehicle 10 and be pulled out of the vehicle 10 to connect to the battery charger 300. Such a configuration may eliminate the need for the charger connection 140 or a portion of the charger connection 140 (e.g., the connection pins, etc.). Additionally or alternatively, the cable 360 may retract into the body of the battery charger 300 and be pulled out of the battery charger 300 to connect to the vehicle 10.

According to some embodiments, the battery charger 300 is configured to provide a charging electrical current to the vehicle 10 to charge the battery module 57 and/or the add-on battery module 59. The battery charger 300 may respond to communications (e.g., commands, requests, information transfer, etc.) from the vehicle 10 over a PWM communication line. For example, the battery charger 300 may provide a particular voltage and/or current requested by the vehicle 10 to match the specifications of the battery stored (or calculated) by the battery configuration 134. As shown in FIG. 5, the battery charger 300 includes a processing circuit 302, a communications interface 306, a PWM circuit 307, a charge circuit 316, a vehicle connection 350, and memory 304 storing instructions for a charge monitor 312 and the PWM communication protocol 132.

The vehicle connection 350 may be any appropriate connection housing. For example, the connection housing may be a plug-type housing with conductive contact points (e.g., pins, slots, etc.) to allow for an electrical connection to be made between the cable 360 and the vehicle connection 350. The housing may be of any suitable shape (e.g., triangular, rectangular, circular, etc.) and may have keying (e.g., protrusions or other irregularities of the connection) to prevent incorrect installation. Similar to the charger connection 140, the vehicle connection 350 may also include circuitry (e.g., relays, etc.) to allow for disconnecting the battery charger 300 from the vehicle 10 by opening a circuit inside the vehicle connection 350.

The charge circuit 316 is shown to provide the charging current on the B+ and B− wires of the battery charger 300. The charge circuit 316 may receive AC line voltage (e.g., 120 V at 60 Hz, 230 V at 50 Hz, etc.) and generate the appropriate DC B+ voltage for charging the batteries of the vehicle 10. The charge circuit 316 may use a combination of a rectifier (e.g., using diodes or synchronized transistors) configured to convert the AC power to DC and a DC-to-DC converter (e.g., buck converter, boost converter, buck-boost converter, Cuk converter, linear regulator, etc.) configured to output the desired voltage. In some embodiments, feedback is used to cause the voltage output to be equal to a requested voltage (e.g., communicated to the charge circuit 316). For example, the feedback loop may be used to precisely control the output voltage by adjusting the duty cycle of a switching converter (e.g., buck, boost, etc.) in response to changing input voltages (e.g., due to changing line voltages, current changes, circuit heating, etc.).

The processing circuit 302 may include a general-purpose microprocessor, a microcontroller, an ASIC, one or more FPGAs, a DSP, circuits containing one or more processing components, circuitry for supporting a microprocessor, a group of processing components, or other suitable electronic processing components. In some embodiments, the processing circuit 302 is configured to execute computer code stored in the memory 304 to facilitate the operations of the battery charger 300. The memory 304 may be any volatile, non-volatile, or non-transitory computer-readable storage medium capable of storing data or computer code relating to the operations of the battery charger 300. According to an exemplary embodiment, the memory 304 includes computer code modules (e.g., executable code, object code, source code, script code, machine code, etc.) configured for execution by the processing circuit 302. For example, the memory 304 may include the charge monitor 312 and the PWM communication protocol 132.

The communications interface 306 may provide communications between various components of the battery charger 300. For example, the communications interface 306 may provide communications between the processing circuit 302 and the charge circuit 316 (e.g., to change the output voltage of the charge circuit 316). The communications interface 306 may also provide communication between the battery charger 300 and the vehicle 10.

In some embodiments, the communication between components of the battery charger 300 and/or external communications (e.g., with the vehicle 10) is performed over a PWM line 142 using a PWM signal 512 as described herein. The PWM circuit 307 may be similar to the PWM circuit 107 of the vehicle 10. The PWM circuit 307 may be one or more electronic components configured to provide a PWM signal 512 at a specified duty cycle. The PWM circuit 307 may be a portion of the processing circuit 302. For example, a microcontroller and/or a microprocessor of the processing circuit 302 may have an integrated PWM interface and provide one or more pins (e.g., connection points, etc.) that can be used to generate a PWM signal or as an input to determine the duty cycle of a PWM signal 512 generated by a different circuit. The PWM circuit 307 may, additionally or alternatively, be a portion of the communications interface 306. For example, the communications interface 306 may include circuitry (e.g., specific integrated circuits, another microcontroller, etc.) to generate a PWM signal 512 based on information received from the processing circuit 302. The processing circuit 302 may provide a duty cycle to the PWM circuit 307 or the processing circuit 302 may provide a sequence of binary data to be communicated which are encoded into a PWM signal 512 by the PWM circuit 307 as described previously herein.

In some embodiments, the PWM communication protocol 132 in the battery charger 300 allows the battery charger 300 to communicate with the vehicle 10 over the PWM line 142. The PWM communication protocol 132 of the battery charger 300 may be configured similarly to that of the vehicle 10 to allow for communication. The PWM communication protocol 132 in the battery charger 300 may be configured to represent a binary ‘0’ and/or a binary ‘1’ using different duty cycles than those used by the vehicle 10 (e.g., to allow identification based on the duty cycles). In addition, and as described previously, the PWM communication protocol 132 may be configured to represent errors, fault conditions, and/or high priority information with a specific duty cycle of the PWM signal 512, allowing for interruption of lower priority communication if immediate action is beneficial.

The charge monitor 312 may be configured to monitor the battery charger 300 for fault conditions and/or to initiate a mitigating action, according to some embodiments. The charge monitor 312 may detect a fault and cause the fault to be indicated by a duty cycle on the PWM line 142 that exceeds a fault threshold (e.g., low threshold or high threshold). The charge monitor 312 may monitor for overtemperature, a rapid increase in charge current, a change in charge voltage, an inability to meet the requested charge etc., and request (e.g., command, cause, etc.) the vehicle 10 to be electrically disconnected from the battery charger 300 by driving the duty cycle of the PWM line 142 to exceed the fault threshold. In some embodiments, the vehicle system 150 includes only a single monitor (e.g., either battery monitor 136 or charge monitor 312) and the monitor that is present is configured to monitor both the vehicle 10 and its battery system (e.g., battery module 57, add-on battery module 59, and BMS 112), as well as the battery charger 300 for various fault conditions.

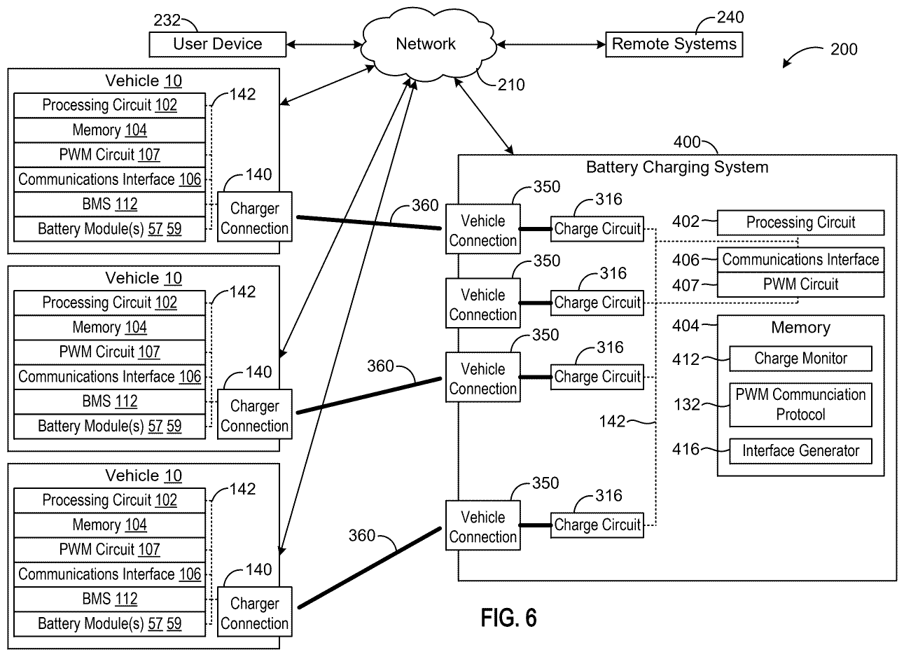

As shown in FIG. 6, the fleet monitoring and control system 200 may include a battery charging system 400 in some embodiments. The battery charging system 400 may be configured to simultaneously charge a number of vehicles 10. The battery charging system 400 is shown to include a number of vehicle connections 350 and a number of charge circuits 316 controlled by communications from a processing circuit 402 by way of a communications interface 406. Similar to the battery charger 300, in some embodiments, the battery charging system 400 is configured to communicate with the charge circuits 316 using a single PWM line 142 and to communicate with the vehicles 10 using the single PWM line 142 connected to the communications interface 406 and PWM circuitry 407. The communications interface 406 and the PWM circuitry 407 may be similar to those components already described for the vehicle 10 and/or the battery charger 300.

As shown in FIG. 6, in some embodiments, the battery charging system 400 is configured to communicate with the remote systems 240 and/or the user device 232 by way of the communications network 210. The remote systems 240 (e.g., off-site server 250 and/or on-site system 260) may be used by the battery charging system 400 to display information related to the charging of the vehicles 10. For example, the remote systems 240 may generate a user interface that includes a display of the current charging rate, the state of charge, the time remaining for full charge, the current vehicle range, and/or any other suitable information related to the fleet of vehicles 10. The remote systems 240 may also be used to stop charging of a particular vehicle, to charge more rapidly, and/or to send other commands to the battery charging system 400. Similar information may be displayed using the user device 232. The user device 232 may be a device of a fleet manager and the user interface provided by the user device 232 may be substantially similar to that of the remote systems 240. For example, the same information and/or configuration options may be provided, but in a mobile format. The user device 232 may alternatively be a device of a customer and the user interface may provide limited information related to the particular vehicle 10 that the customer is assigned (e.g., state-of-charge). In some embodiments, fleet-wide information may be provided to the device of a customer to allow them to choose a vehicle 10 (e.g., choosing a golf vehicle at a country club).

The processing circuit 402 of the battery charging system 400 may include a general-purpose microprocessor, a microcontroller, an ASIC, one or more FPGAs, a DSP, circuits containing one or more processing components, circuitry for supporting a microprocessor, a group of processing components, or other suitable electronic processing components. In some embodiments, the processing circuit 402 is configured to execute computer code stored in the memory 404 to facilitate the operations of the battery charging system 400. The memory 404 may be any volatile or non-volatile or non-transitory computer-readable storage medium capable of storing data or computer code relating to the operations of the battery charging system 400. According to an exemplary embodiment, the memory 404 includes computer code modules (e.g., executable code, object code, source code, script code, machine code, etc.) configured for execution by the processing circuit 402. For example, the memory 404 may include a charge monitor 412, the PWM communication protocol 132 and an interface generator 416.

The charge monitor 412 may be similar to the charge monitor 312, however, the charge monitor 412 may be configured to monitor the condition of several charging procedures simultaneously. Each vehicle 10 currently connected to the battery charging system 400 may be monitored for fault conditions by the charge monitor 412. The charge monitor 412 may be configured to individually cause a vehicle to become disconnected from the battery charging system 400 in response to a fault condition. For example, by causing circuitry in the respective vehicle connection 350 and/or charger connection 140 to electrically disconnect.

The interface generator 416 may be configured to provide instructions to the user device 232 or the remote systems 240, for example, in the form of JavaScript, Cascading Style Sheets, etc. that instruct the user device 232 or the remote systems 240 how to generate the user interface. The user interface may be generated within a client application (e.g., an internet browser, a proprietary application, etc.) and provide information related to the charging of a vehicle 10 or the fleet of vehicles 10. The user interface may provide the current state-of-charge of the vehicles 10, the time remaining for full charge, the current vehicle range, fault conditions, and/or any other suitable information related to the fleet of vehicles 10. In some embodiments, the user interface provides application programming interfaces (APIs) that allow remote commands to be sent to the battery charging system 400 to configure the battery charging system 400 or otherwise change the operation of the battery charging system 400.

The user interface provided by the interface generator 416 may provide a scheduling functionality. The scheduling functionality may recommend and/or optimize a charging schedule for the fleet of vehicles given inputs including the current state-of-charge of each vehicle 10, the predicted usage pattern of the vehicles 10, and the overall charging capacity of the battery charging system 400. For example, a vehicle 10 may be able to accept a charge rate of up to 1.5 kW, but the overall charging capacity of the battery charging system 400 may be 10 kW, thus if more than seven vehicles 10 are connected to the battery charging system 400 at any given time, the battery charging system 400 may not be able to meet a full rate charge request for each of the vehicles 10 simultaneously. The scheduling functionality provided by the interface generator 416 may charge one portion of the connected vehicles 10 for a first time period and then change a different portion of the connected vehicles 10 during a different time period. Alternatively, the scheduling functionality may decide to charge all connected vehicles at a reduced charge rate. Calculations to perform scheduling may be performed in the remote systems 240 and/or by the battery charging system 400 before being displayed on the user interface provided by the interface generator 416.

In some embodiments, communication between the battery charging system 400 and the vehicles 10 (e.g., over a single PWM line 142, bus, etc.) allows for advanced charging capability such as scheduling. Information related to the current state-of-charge of the batteries, future use of the vehicles 10, vehicle charge capacity, and specifications of the battery charging system 400 may all be communicated to a common location (e.g., the remote systems 240 and/or the battery charging system 400) via a combination of the communications network 210 and/or the PWM communication line. According to some embodiments, charging is implemented according to the scheduled plan when the vehicle 10 connects to the battery charging system 400. For example, the schedule may be communicated from the remote systems 240 to the battery charging system 400. Upon connecting, the vehicle 10 may identify itself (e.g., through a unique identifier, vehicle number etc.) and the battery charger 300 may inform the vehicle 10 of the charging plan. Alternatively, the schedule may be delivered from the remote systems 240 to each vehicle 10. Upon connecting to the battery charging system 400, the vehicle 10 may request the scheduled charging rate.

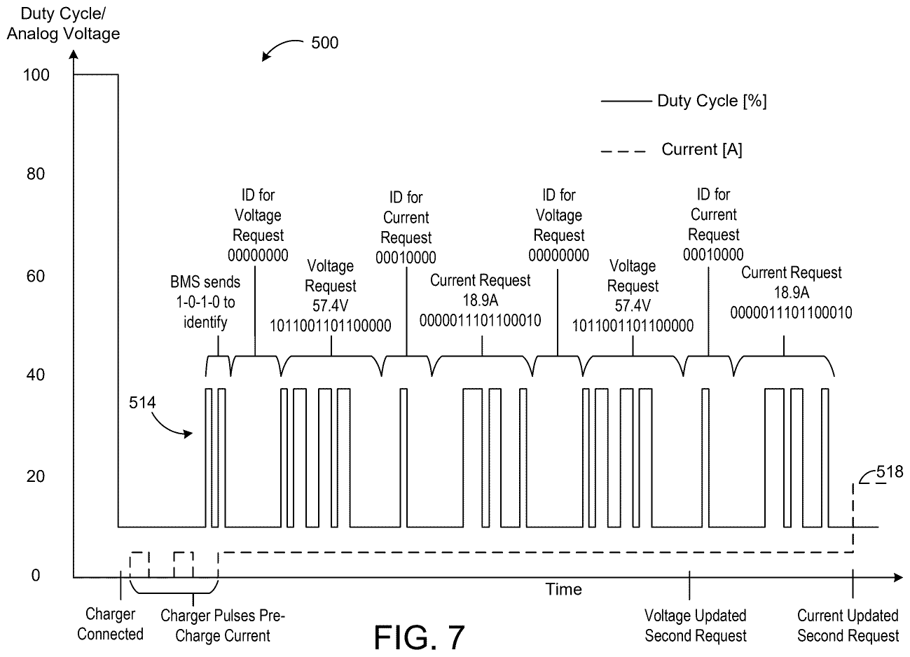

FIG. 7 shows a timing diagram 500 that illustrates the information signal 514 that is communicated by the vehicle 10 to the battery charger 300 and/or the battery charging system 400 during charge initialization, according to some embodiments. The timing diagram 500 also illustrates acknowledgement by the battery charger 300 and/or the battery charging system 400 using the current that is sent to the vehicle 10. It is contemplated that communication back from the battery charger 300 and/or the battery charging system 400 to the vehicle 10 can be performed using various techniques that may depend on the complexity of the information that is to be communicated. For example, some communication may be encoded in pulses of the charging current as shown in FIG. 7 and some communication may be encoded in the duty cycle on the PWM line 142.

Two-way communication on a single PWM line 142 may require monitoring the PWM line 142 to ensure other devices are idle before communication is performed. For example, a duty cycle of 100% or a PWM line 142 voltage equal to vₕ may be used to indicate an idle line that can be used for a new communication. In such configurations, the PWM communication protocol 132 used by the vehicles 10, the battery charger 300, and/or the battery charging system 400 of the vehicle system 150 and/or the fleet monitoring and control system 200 may include instructions for performing collision detection and configuring a PWM pin on a microcontroller or microprocessor to change configuration between an input and output (e.g., transmitting and/or receiving).

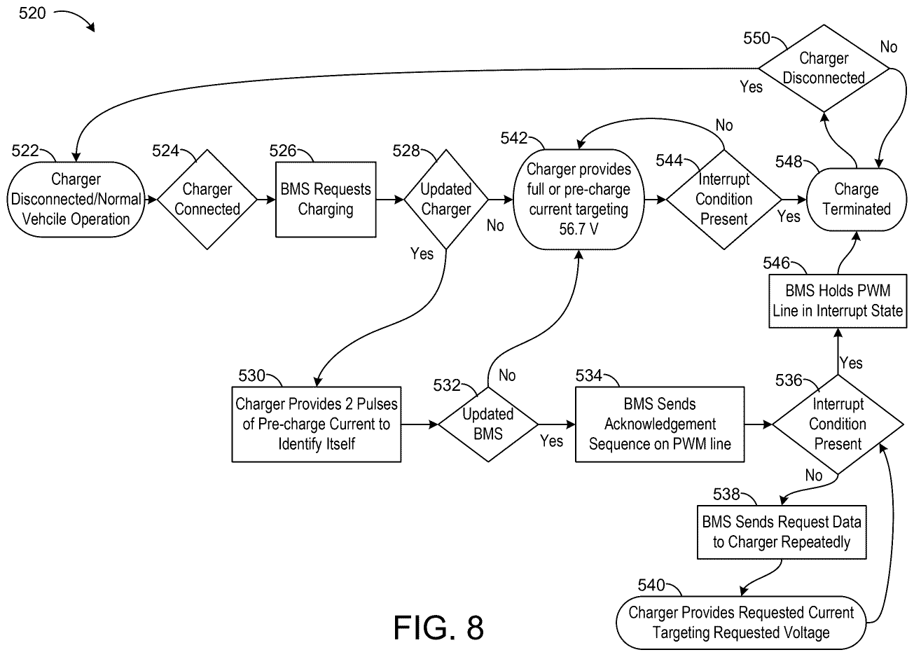

The timing diagram 500 may be described with reference to the flow diagram 520 of FIG. 8. The vehicle 10 may be performing normal operations (e.g., the battery charger 300 or battery charging system 400 is disconnected) in step 522. According to the timing diagram 500, the PWM line 142 is at a high voltage level until the charger is connected. In step 524 of the flow diagram 520, the battery charger 300 or battery charging system 400 is connected, and in step 526 the vehicle 10 requests charging by holding the PWM line 142 at a specific duty cycle. For example, the vehicle 10 may cause the PWM line 142 to be at a first duty cycle, shown to be 8% and equal to the duty cycle that represents a binary ‘0’ in the timing diagram 500.

At step 528 the flow diagram 520 splits based on whether the battery charger 300 or battery charging system 400 is upgraded/updated (e.g., is capable of receiving serial communications over the PWM line 142). If the battery charger or the battery charging system 400 is upgraded/updated, the flow diagram 520 will continue to step 530. At step 530, the battery charger 300 provides a number of pulses of pre-charge current to identify itself as of the upgraded/updated type of charger (shown as the two pulses of the current signal 518). In some embodiments, the vehicle control system 100 is configured to determine whether the battery charger is upgraded or not upgraded, capable of delivering charge at a specific voltage or current, and/or has other attributes associated with the charger capability. For example, the vehicle control system 100 may determine a revision of the charger.

At step 532 the flow diagram 520 splits again based on whether the BMS 112 includes the upgraded/updated type and the vehicle control system 100 is capable of communicating a voltage and/or current request over the PWM line 142. If the BMS 112 is of the upgraded/updated type, the BMS 112 sends an acknowledgement sequence on the PWM line 142 in step 534. The acknowledgement may be any sequence of binary values and is shown as ‘1010’ in the timing diagram 500 of FIG. 7. The battery charger 300 may identify that the BMS 112 is upgraded based on this sequence. The information signal 514 uses a first duty cycle of 8% to represent binary ‘0’ and a second duty cycle of 38% to represent a binary ‘1’. After the acknowledgement indicating that the BMS 112 is of the upgraded type the charging procedure may enter the charging mode. During this mode, the BMS 112 determines if an interrupt condition (e.g., fault condition, error, etc.) is present in step 536 and if no interrupt condition is present the BMS 112 may send a request for the particular voltage and current in step 538. The voltage and current requests are repeatedly sent (e.g., continuously, until the battery charger 300 or battery charging system 400 responds, or a fixed number of times). The battery charger 300 or battery charging system 400 will process the request and deliver the requested current at the targeted voltage in step 540.

Steps 538 and 540 are shown in greater detail in the timing diagram 500. After the acknowledgement and identification sequence of ‘1010’ by information signal 514, the voltage request identifier (e.g., header, etc.) ‘00000000’ is sent by the BMS 112 of the vehicle 10 to indicate that the next value is a requested voltage value in some embodiments. The voltage request identifier may be followed by the binary sequence for the desired voltage (e.g., 57.4 V in timing diagram 500). The value for the requested voltage may be encoded into binary form using any appropriate floating point standard. The voltage request may be followed by the identifier for a current request (e.g., ‘00010000’ in the case of the timing diagram 500) followed by the desired current value (e.g., charge rate) shown as 18.9 A which is encoded as ‘00000011101100010’. The voltage and current requests may be repeated indefinitely or until the battery charger 300 or the battery charging system 400 adjusts its output to the appropriate current and voltage in step 540. In the timing diagram 500, the current and voltage update is shown by the increase in the current signal 518 (shown as the dashed line).

The flow diagram 520 may be incorporated into the PWM communication protocol 132 to provide communication between the vehicle 10 and the battery charger 300 or the battery charging system 400. The flow diagram 520 also includes aspects of the PWM communication protocol 132 already described. If an interrupt condition is present at step 536, the BMS 112 of the vehicle 10 holds the PWM line 142 in an interrupt state in operation 546. For example, a duty cycle above a high threshold (e.g., 95%) or below a low threshold (e.g., 5%) may be used to indicate an interrupt request. This indicates that charging should be terminated in step 548. At step 550, if the battery charger 300 has not yet been disconnected, the request of step 548 remains or if the charger has been disconnected, operation flow returns to the normal operation state of step 522 with a disconnected charger.

The PWM communication protocol 132 described by flow diagram 520 and timing diagram 500 also provides backwards compatibility between an updated vehicle 10 (e.g., including the PWM communication protocol 132) and a battery charger 300 or a battery charging system 400 that has not yet been updated. In flow diagram 520 if an updated BMS 112 is connected to a battery charger 300 or a battery charging system 400 that has not been updated, the battery charger 300 or the battery charging system 400 will not identify itself as such and at step 528 operations will continue to step 542 where the charger provides a default current (e.g., pre-charge or full-charge) at a default voltage (e.g., 56.7 V).

PWM communication protocol 132 described by flow diagram 520 and timing diagram 500 also provides backwards compatibility between an updated battery charger 300 or updated battery charging system 400 (e.g., including the PWM communication protocol 132) and a vehicle 10 that has not yet been updated with the PWM communication protocol 132 and associated electronics. In such a scenario, at step 532 the BMS 112 will not send an acknowledgment sequence (e.g., ‘0101’) and flow will instead continue to step 542. The battery charger 300 or the battery charging system 400 may provide a default current (e.g., pre-charge or full-charge) at a default voltage (e.g., 56.7 V) at step 542. In some embodiments, vehicles 10 and/or chargers that have not been updated can still indicate a need to stop charging (e.g., an interrupt) causing flow to continue to step 548 within which charging is terminated.

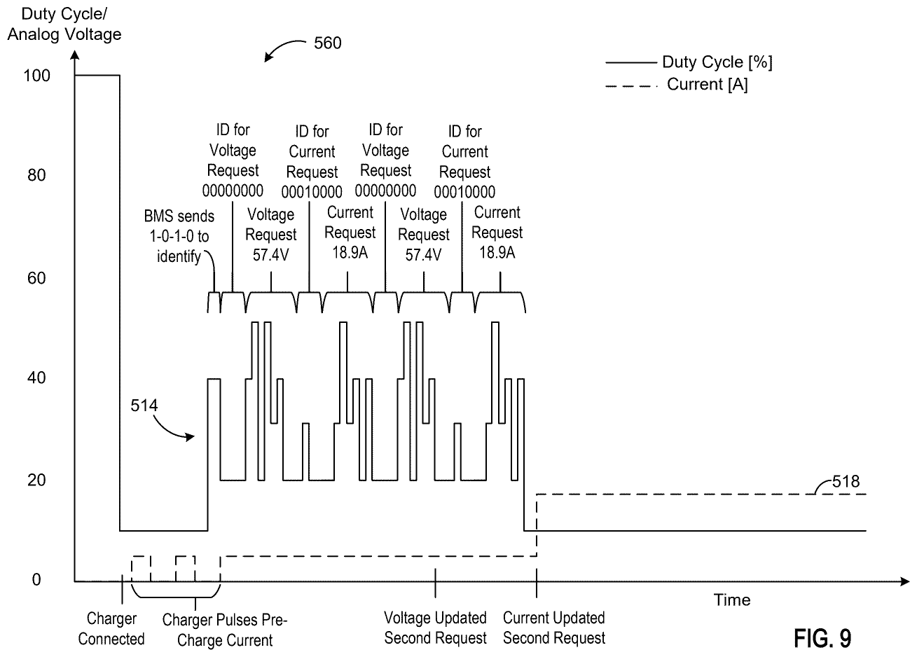

Other advantages of the PWM communication protocol 132 may be included with the flow diagram 520. More than one binary symbol may be communicated over the PWM line 142 simultaneously. In such an implementation, it is possible that the flow diagram 520 does not change, but rather communication speed is increased. FIG. 9 shows timing diagram 560 for an implementation where a 20% duty cycle represents ‘00’, a 30% duty cycle represents ‘01’, a 40% duty cycle represents ‘10’, and a 50% duty cycle represents ‘11’, a duty cycle of 8% is also used to represent no communication. As shown in FIG. 9, the communication is performed in half the number of clock cycles and the current is updated sooner.

In some embodiments, the BMS 112 may identify itself by using particular values for the PWM duty cycle that represent a binary ‘0’ and a binary ‘1’ rather than sending the ‘1010’ identification signal. Similarly, the voltage request and/or current request may be indicated using specific duty cycle values to represent a binary ‘0’ and a binary ‘1’ rather than sending ‘00000000’ or ‘00010000’ as identification sequences to further speed communication. A combination of using specific duty cycles to identify the source of the request and/or the type of request may be combined with using multiple duty cycles to communicate more than one binary symbol at a time.

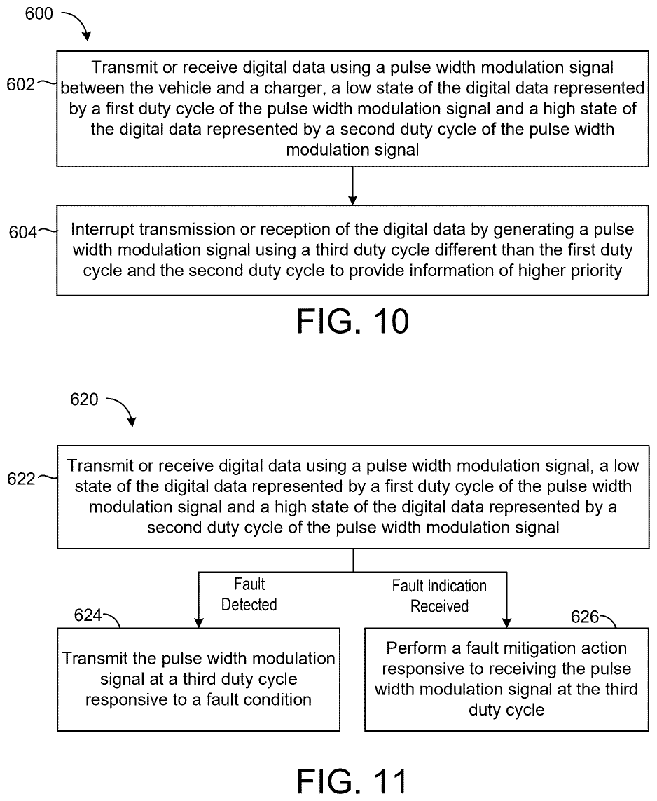

FIG. 10 shows a method 600 for interrupting communication between a vehicle 10 and a battery charger 300 or battery charging system 400 to allow for a higher priority communication, according to some embodiments. The method 600 may include transmitting or receiving digital data using a PWM signal 512 between the vehicle and an charger (e.g., the battery charger 300 or the battery charging system 400), a low state of the digital data represented by a first duty cycle of the pulse width modulation signal and a high state of the digital data represented by a second duty cycle of the pulse width modulation signal in an operation 602. For example, the BMS 112 may be sending information related to a desired charge current (e.g., rate). A first duty cycle (e.g., 8%) may be used to represent a low state of the digital data (e.g., a binary ‘0’), whereas a second duty cycle (e.g., 38%) may be used to represent a high state of the digital data (e.g., a binary ‘1’).

In some embodiments, the vehicle 10 may also communicate the state-of-charge and/or other battery parameters, conditions, or specifications to the charger. This information may be displayed by the charger (e.g., on the charger or delivered to a remote systems 240 for display). After receiving the requested voltage and/or charge current, the battery charger may adjust the charge circuit 316 to output the request.

The method 600 may include interrupting transmission or reception of the digital data by generating the pulse width modulation signal 512 using a third duty cycle different than the first duty cycle and the second duty cycle to provide information of higher priority in an operation 604. The operation 604 may be performed responsive to the battery monitor 136 and/or the charge monitor 312 or 412 detecting a fault condition in the vehicle 10, battery charger 300, and/or the battery charging system 400. Responsive to the fault condition, the pulse width modulation signal 512 may be modified to have a third duty cycle. For example, the duty cycle may be lowered (or raised) to a value that exceeds a fault threshold (e.g., greater than 95% or less than 5%).

After the indicating the fault condition with the third duty cycle, the component that detected the fault condition may communicate information related to the fault condition. Additionally or alternatively, the fault condition or a necessary action (e.g., disconnecting the charger) may be indicated directly by the duty cycle and the mitigating action can be taken immediately without waiting for additional communication. Advantageously, certain battery, charger, and/or connection faults may manifest with the PWM line 142 being pulled to a reference voltage, vₗ, or to a high voltage, vₕ, and using a duty cycle above a high threshold or below a low threshold to represent a fault condition and/or a disconnect request allows for the charger to be disconnected even if the vehicle 10 and the charger are unable to communicate due to a compromised communication line. It is noted that certain short circuits resulting from damaged circuit boards and or components may result in the PWM line 142 being pulled to a reference voltage or to a high voltage.

FIG. 11 shows a method 620 for performing fault mitigation using communications over a PWM line 142, according to some embodiments. The method 620 may include transmitting or receiving digital data using a pulse width modulation signal, a low state of the digital data represented by a first duty cycle of the pulse width modulation signal and a high state of the digital data represented by a second duty cycle of the pulse width modulation signal in an operation 622. For example, the communications may be performed between the vehicle 10 and the battery charger 300, and/or the battery charging system 400 where a first duty cycle (e.g., 8%) may be used to represent a low state of the digital data (e.g., a binary ‘0’) whereas a second duty cycle (e.g., 38%) may be used to represent a high state of the digital data (e.g., a binary ‘1’).

If a fault is detected by a device (or component), that device may transmit the pulse width modulation signal at a third duty cycle responsive to a fault condition in an operation 624 (e.g., to indicate the fault condition to other devices communicating over the PWM line 142). The pulse width modulation signal may be modified to have a third duty cycle. For example, the duty cycle may be lowered (or raised) to a value that exceeds a fault threshold (e.g., greater than 95% or less than 5%). If an indication of a fault is received by a device or component, that device may perform a fault mitigation action responsive to receiving the pulse width modulation signal at the third duty cycle in an operation 626. The mitigating action may depend on the fault condition. If the fault is severe, the mitigating action may be to electrically disconnect the communicating devices (e.g., to isolate the fault condition). For example, a relay system may be used to electrically disconnect the vehicle 10 from the battery charger 300, and/or the battery charging system 400.

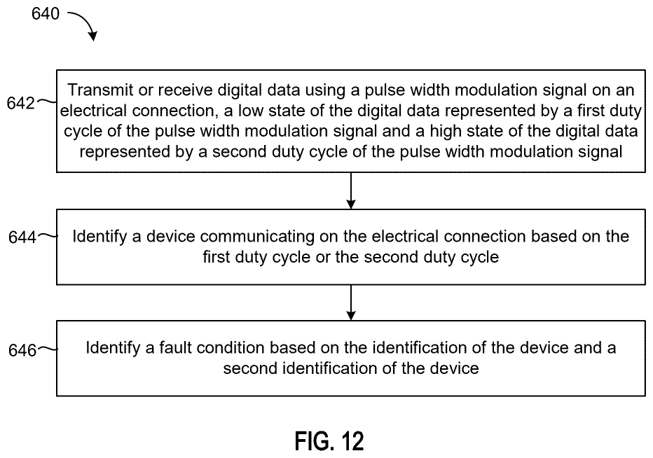

FIG. 12 shows a method 640 for identifying a device based on a PWM communication signal and performing fault detection based on the identification, according to some embodiments. The method 640 may be performed by any of the components of the vehicle system 150 and/or the fleet monitoring and control system 200. The method 640 may include transmitting or receiving digital data using a pulse width modulation signal on an electrical connection, a low state of the digital data represented by a first duty cycle of the pulse width modulation signal and a high state of the digital data represented by a second duty cycle of the pulse width modulation signal in an operation 642.

The method 640 may include identifying a device communicating on the electrical connection based on the first duty cycle or the second duty cycle in operation 644. The PWM communication protocol 132 may be configured to allow component identification (e.g., unique identity of the source or type of the source) based on the duty cycles used by the PWM signal 512 to represent the binary symbol ‘0’ (e.g., the first value of the duty cycle) and/or the binary symbol ‘1’ (e.g., the second value of the duty cycle). For example, the PWM communication protocol 132 may be configured to recognize that a PWM signal 512 that changes between a duty cycle of 40% (e.g., the first value to represent ‘0’) and 75% (e.g., the second value to represent ‘1’) is from a vehicle 10 and a communication using a PWM signal 512 that changes between a duty cycle of 30% and 50% is from a battery charger 300. Each component of the vehicle system 150 and/or the fleet monitoring and control system 200 may be assigned a unique first value and second value to represent the binary symbols the component transmits. In some embodiments, only a first duty cycle (e.g., used to represent binary ‘0’) or only a second duty cycle (e.g., used to represent a binary ‘1’) is used to perform the identification.

In some embodiments, the method 640 includes identifying a fault condition based on the identification of the device and a second identification of the device. The second identification of the device may be performed using a different technique. The PWM communication protocol 132 may be configured such that each component has a specific order or time at which they are able to communicate (e.g., a token-passing network). The PWM communication protocol 132 can provide the second identification based on the timing and/or order for which they communicate. By way of example, a second identification may be based on the holder of the token in a token passing network and compared to the identification based on the PWM duty cycles of the operation 644. The PWM communication protocol 132 may be configured to identify a fault by comparing both forms of identification. If the two identifications do not match, the PWM communication protocol 132 may output an error. For example, the error may be displayed on the operator interface 48, cause the battery charger 300 to disconnect, cause a restart (e.g., reset) of the communication, cause a reset of the potentially offending components (e.g., both components that were identified), or any other suitable technique that may clear the communication problem and/or mitigate any effect of the fault.

As utilized herein with respect to numerical ranges, the terms “approximately,” “about,” “substantially,” and similar terms generally mean±/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A vehicle system comprising:
a vehicle including:
a battery; and
charger connection interface configured to connect to a charger; and
one or more processing circuits configured to:
transmit or receive digital data using a pulse width modulation signal between the vehicle and the charger, a low state of the digital data represented by a first duty cycle of the pulse width modulation signal and a high state of the digital data represented by a second duty cycle of the pulse width modulation signal; and
interrupt transmission or reception of the digital data by generating the pulse width modulation signal using a third duty cycle different than the first duty cycle and the second duty cycle to provide information of higher priority.

2. The vehicle system of claim 1, the vehicle or the charger further comprising a filter configured to generate a voltage proportional to a respective duty cycle of the pulse width modulation signal.

3. The vehicle system of claim 1, wherein the one or more processing circuits are configured to determine a revision or a type of the charger.

4. The vehicle system of claim 1, wherein transmitting the digital data comprises requesting a voltage level or a current amount from the charger.

5. The vehicle system of claim 1, wherein transmitting the digital data comprises transmitting parameters of a battery system of the vehicle.

6. The vehicle system of claim 1, wherein the one or more processing circuits are configured to transmit a request to terminate charging by transmitting the pulse width modulation signal with the third duty cycle, wherein the third duty cycle is less than a low threshold or greater than a high threshold.

7. The vehicle system of claim 1, wherein the one or more processing circuits are configured to transmit a request to electrically disconnect the charger by transmitting the pulse width modulation signal with the third duty cycle responsive to a fault condition, wherein the third duty cycle less than a low threshold or greater than a high threshold.

8. The vehicle system of claim 1, further comprising the charger, wherein the charger is an off-board charger.

9. The vehicle system of claim 8, wherein the off-board charger is configured to communicate to the vehicle by transmitting the digital data using a second pulse width modulation signal via the charger connection interface.

10. The vehicle system of claim 8, wherein:
communicating with the off-board charger comprises transmitting a current state of charge of a battery system of the vehicle; and
the off-board charger is configured to display the current state of charge.

11. The vehicle system of claim 10, wherein the vehicle is of a plurality of vehicles and the off-board charger is configured to connect to the plurality of vehicles and transmit the current state of charge to a remote management system.

12. The vehicle system of claim 1, wherein the charger connection interface comprises:
a positive voltage connection;
a reference voltage connection; and
a connection to carry the pulse width modulation signal.

13. The vehicle system of claim 1, wherein the first duty cycle and the second duty cycle represents a priority of the digital data.

14. The vehicle system of claim 1, wherein the one or more processing circuits are configured to transmit a number of bits of the digital data simultaneously, a sequence of low bits and high bits of length equal to the number of bits represented by a corresponding duty cycle.

15. A vehicle system comprising:
one or more processing circuits configured to:
transmit or receive digital data using a pulse width modulation signal, a low state of the digital data represented by a first duty cycle of the pulse width modulation signal and a high state of the digital data represented by a second duty cycle of the pulse width modulation signal; and
(i) transmit the pulse width modulation signal at a third duty cycle responsive to a fault condition, or (ii) perform a fault mitigation action responsive to the pulse width modulation signal at the third duty cycle.

16. The vehicle system of claim 15, wherein the one or more processing circuits are configured to communicate to a charger using the pulse width modulation signal.

17. The vehicle system of claim 16, wherein communicating with the charger using the pulse width modulation signal comprises transmitting at least one of:
parameters of a battery system of the vehicle system;
a request for a voltage level;
a current amount from the charger;
a request to terminate charging; or
a request to electrically disconnect the charger.

18. A vehicle system comprising:
one or more processing circuits configured to:
transmit or receive digital data using a pulse width modulation signal on an electrical connection, a low state of the digital data represented by a first duty cycle of the pulse width modulation signal and a high state of the digital data represented by a second duty cycle of the pulse width modulation signal; and
perform an identification of a device communicating on the electrical connection based on the first duty cycle or the second duty cycle.

19. The vehicle system of claim 18, wherein the identification of the device is a first identification of the device and the one or more processing circuits are configured to identify a fault condition based on the first identification of the device and a second identification of the device.

20. The vehicle system of claim 19, wherein the one or more processing circuits are configured to communicate the digital data to a charger using the pulse width modulation signal, the digital data comprising transmitting at least one of:
parameters of a battery system of the vehicle system;
a request for a voltage level;
a current amount from the charger;
a request to terminate charging; or
a request to electrically disconnect the charger.
